(19) United States
(12) Patent Application Publication
(10) Pub. No.: US 2025/0358110 A1
(43) Pub. Date: Nov. 20, 2025

(54) EXTENDING FIRMWARE VERIFICATION TO OTHER COMPONENTS WITHIN SYSTEM AS PART OF CHAIN OF TRUST

(71) Applicant: American Megatrends International LLC, Duluth, GA (US)

(72) Inventors: ANURAG BHATIA, Sugar Hill, GA (US); Winston Thangapandian, Suwanee, GA (US); Valantina Arumugam, Chennai (IN)

(21) Appl. No.: 18/664,589

(22) Filed: May 15, 2024

(51) Int. Cl. H04L 9/14; H04L 9/30

(52) U.S. Cl. CPC H04L 9/14; H04L 9/3066

(57) ABSTRACT

A BMC determines to reboot a hardware component. A firmware image for the hardware component is stored in a non-volatile memory of the hardware component. The BMC reads the firmware image of the hardware component from the non-volatile memory of the hardware component. The BMC verifies the firmware image of the hardware component using a public key of a public-private key pair to determine integrity and authenticity of the firmware image. The public key is stored in a BMC firmware image. The BMC allows the hardware component to boot from the firmware image in response to the firmware image passing the verification.

### BACKGROUND

### Field

The present disclosure relates generally to computer systems, and more particularly, to techniques of verifying integrity and authenticity of firmware images for various hardware components of a system using a baseboard management controller (BMC) before allowing the hardware components to boot up.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is a BMC. The BMC determines to reboot a hardware component. A firmware image for the hardware component is stored in a non-volatile memory of the hardware component. The BMC reads the firmware image of the hardware component from the non-volatile memory of the hardware component. The BMC verifies the firmware image of the hardware component using a public key of a public-private key pair to determine integrity and authenticity of the firmware image. The public key is stored in a BMC firmware image. The BMC allows the hardware component to boot from the firmware image in response to the firmware image passing the verification.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating a BMC firmware image.

FIG. 3 is a diagram illustrating validation procedures utilized in a bootup process of the BMC.

FIG. 4 is a diagram illustrating a BMC connected to various hardware components of a host computer.

FIG. 5 is a flow chart of a method (process) for verifying and booting a firmware image of a hardware component.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

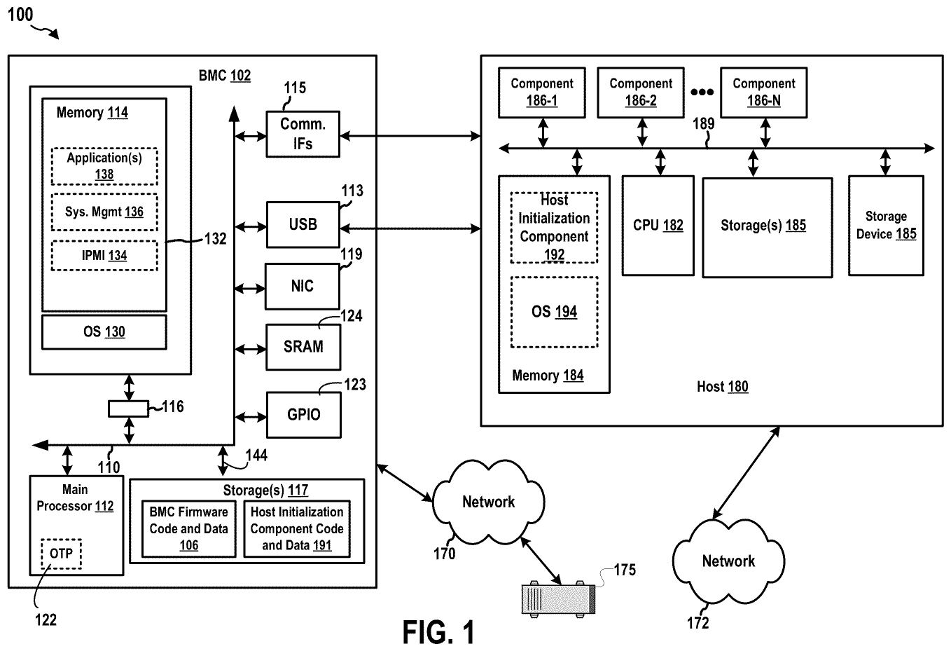

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface). Further, the main processing unit 112 contains an OTP memory 122 (i.e., one time programmable memory).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 a BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

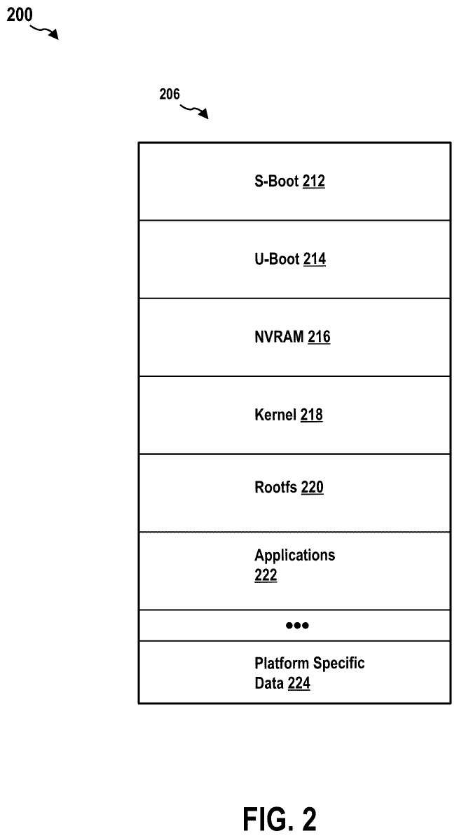

FIG. 2 is a diagram 200 illustrating a BMC firmware image 206, which is an exemplary image containing the BMC firmware code and data 106. The BMC firmware image 206 contains data sections of an S-Boot 212 (i.e., a first boot program), a U-Boot 214 (i.e., a second boot program), a NVRAM 216 (i.e., non-volatile random-access memory), a kernel 218, a rootfs 220 (i.e., root file system), applications 222, and platform specific data 224.

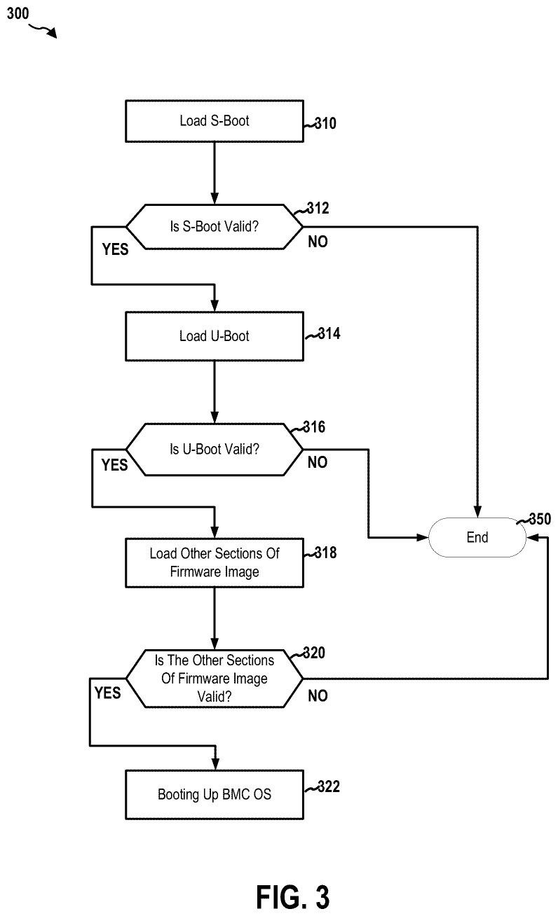

FIG. 3 is a diagram 300 illustrating validation procedures utilized in a bootup process of the BMC 102. After the BMC 102 is powered on or reset, the BMC 102 enters a booting process. In procedure 310, the processing unit 112 loads, from the storage 117, the data section of the BMC firmware image 206 containing the S-Boot 212 (e.g., the initial 64 KB) into the SRAM 124. The data of this section are encrypted with the private key A of a first public key/private key pair.

In procedure 312, the processing unit 112 validates the data section of the S-Boot 212. In particular, the OTP memory 122 of the processing unit 112 is programmed with the public key A of the first public key/private key pair. The processing unit 112 retrieves the public key A from the OTP memory 122, and uses the public key A to decrypt the data section of the S-Boot 212. As such, the decrypted data of the S-Boot 212 are stored in the SRAM 124. Further, in certain configurations, the processing unit 112 may calculate a hash for the decrypted data of the S-Boot 212 and extract another hash stored in the decrypted data. The processing unit 112 then compares the calculated hash and the stored hash to determine if the S-Boot 212 is valid.

When the data section containing the S-Boot 212 is not valid, the processing unit 112 enters procedure 350, in which the booting process is ended. When data of the S-Boot 212 is valid, the processing unit 112 executes the S-Boot 212. The S-Boot 212 initializes the memory 114 (e.g., a DRAM). Subsequently, in procedure 314, the S-Boot 212 loads the data section of the BMC firmware image 206 containing the U-Boot 214 into the memory 114. In procedure 316, the S-Boot 212 then validates the data of the U-Boot 214. For example, similar to what was described supra, the processing unit 112 may use hashes to validate the data section containing the U-Boot 214.

When the data section containing the U-Boot 214 is not valid, the S-Boot 212 enters procedure 350, in which the booting process is ended. When data section containing the U-Boot 214 is valid, the S-Boot 212 passes control to the U-Boot 214. That is, the processing unit 112 executes the U-Boot 214 and enters procedure 318.

In procedure 318, the U-Boot 214 then loads the remainder of the BMC firmware image 206 (e.g., data sections of the NVRAM 216, the kernel 218, the rootfs 220, the applications 222, the platform specific data 224, etc.) into the memory 114. In certain configurations, the data sections of the kernel 218, the rootfs 220, the applications 222, and/or other components are encrypted by the private key B of a second public key/private key pair. Further, the platform specific data 224 contain the public key B of the second public key/private key pair.

In procedure 320, the U-Boot 214 validates those data sections of the BMC firmware image 206. In particular, the U-Boot 214 retrieves the public key B from the platform specific data 224 and uses the public key B to decrypt the data sections containing the kernel 218, the rootfs 220, the applications 222, etc. Further, similar to what was described supra, the processing unit 112 may use hashes to validate the data containing those components.

When the data sections of the kernel 218, the rootfs 220, the applications 222, and/or other components are not valid, the U-Boot 214 enters procedure 350, in which the booting process is ended. When those sections are valid, in procedure 322, the BMC OS 130 is booted up. In particular, the U-Boot 214 passes the control to the kernel 218. The kernel 218 then initializes the rootfs 220. The kernel 218 then mounts the NVRAM 216 (e.g., utilizing the SRAM 124). The NVRAM 216 may contain system configuration information, such as settings for the hardware and the BMC firmware. The applications 222 (e.g., the IPMI services 134, the system management component 136, and the application(s) 138) are then started.

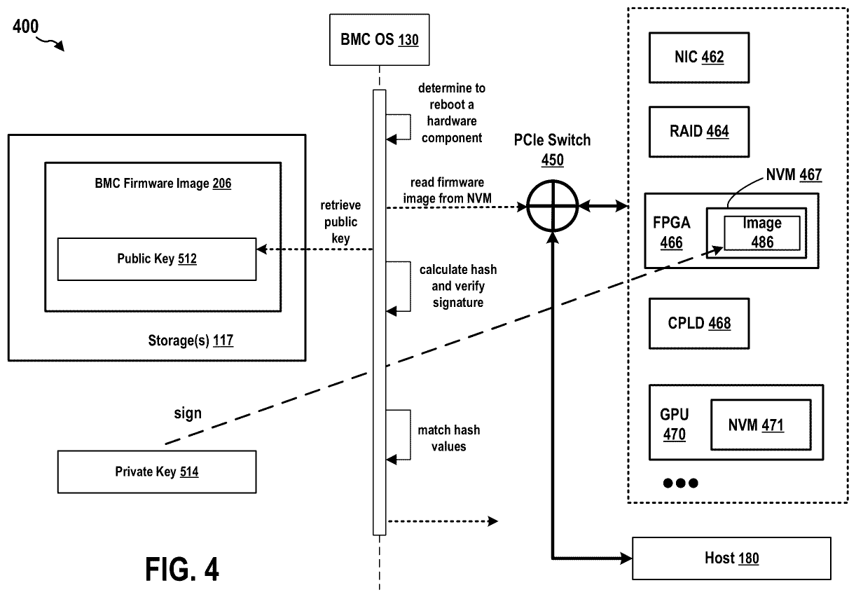

FIG. 4 is a diagram 400 illustrating a BMC 102 connected to various hardware components of a host computer 180, where the BMC 102 verifies the integrity and authenticity of the firmware images stored in the non-volatile memories of the hardware components before allowing them to boot up, as part of maintaining a chain of trust for the entire server system. In this example, the host computer 180 has one or more components such as a network interface card (NIC) 462, a redundant array of independent disks (RAID) 464, a field-programmable gate array (FPGA) 466, a complex programmable logic device (CPLD) 468, a graphics processing unit (GPU) 470, etc. The host CPU 182 may be in communication with the components through one or more communication links such as Peripheral Component Interconnect Express (PCIe), Inter-Integrated Circuit (I2C), Improved Inter-Integrated Circuit (I3C), Serial Peripheral Interface (SPI), etc. In this example, the host CPU 182 is connected with the components via PCIe links and a PCIe switch 450. Similarly, the BMC 102 is also connected with the components via the PCIe links and the PCIe switch 450.

Further, each of the components (including the PCIe switch 450) may utilize a non-volatile memory (NVM) to store an image of the firmware of the component. For example, the FPGA 466 utilizes an NVM 467, and the GPU 470 utilizes an NVM 471. In a booting process, a processor of the component may load the firmware image from the NVM into a volatile memory and executes the firmware of the component.

In addition to the BIOS firmware validation for secured server boot, the BMC OS 130 can also validate the firmware of other server components such as the NIC 462, the RAID 464, the FPGA 466, the CPLD 468, the GPU 470, and the PCIe switch 450. The BMC 102 maintains a secured boot of the complete server system, including all firmware components that could be vulnerable to tampering, thus compromising the critical server system security.

The BMC 102 may control all power sequencing operations for the server components. Upon server boot, the BMC OS 130 first accesses and validates the firmware of each component. Only when the BMC OS 130 confirms an authenticated firmware image on each component, it allows booting of that hardware component.

The vendor for each hardware component may use a private key 514 to encrypt and generate a digital signature for the firmware image. The corresponding public key 512 is stored inside the BMC firmware image 206 and used by the BMC OS 130 to authenticate the component's firmware before allowing it to boot. This technique can leverage any industry specification or the component's vendor-specific implementation to enforce the authentication before the system is allowed to boot.

More specifically, the BMC firmware image 206 holds the public key 512 or X and Y components of the public key 512, which is part of a public key/private key pair specific to the firmware image of each component, such as the FPGA 466. The X and Y components are the compressed form of Elliptic Curve (EC) secp384r1 or prime256v1 based public key, representing coordinates on an elliptic curve. The corresponding private key 514 is used to sign the firmware image.

In certain configurations, the firmware image has been signed using the Elliptic Curve Digital Signature Algorithm (ECDSA) with the private key 514. During the signing process, the ECDSA signature generation process is applied to the entire firmware image. A cryptographic hash function (e.g., SHA-256) is applied to the firmware image to generate a unique digest representing the data. This digest protects data integrity and detects any modifications. The private key 514 is used to sign the hash of the firmware image using the ECDSA algorithm. The signing process involves complex mathematical operations on the elliptic curve and results in a signature consisting of two values, {r, s}. The generated ECDSA signature {r, s} is stored within the firmware image itself, typically within a dedicated signature section or appended to the firmware image.

In certain scenarios, the BMC 102 may determine to reboot the host computer 180 (including all the hardware components) or to reboot (reset) a particular hardware component. In each scenario, the particular component is to be rebooted using the firmware image stored in the NVM of the hardware component. Accordingly, the BMC OS 130 verifies the integrity of the firmware image prior to powering on or resetting the hardware component.

More specifically, in this example, the BMC OS 130 retrieves the public key 512 from the BMC firmware image 206. The BMC OS 130 reads the firmware image (e.g., firmware 486 of the FPGA 466) from the corresponding NVM, such as the NVM 467 for the FPGA 466. The BMC OS 130 calculates a hash value of the firmware image and inputs it along with the corresponding signature {r, s} to the ECDSA signature verification algorithm. The output is a boolean value indicating whether the signature is valid or invalid. This algorithm performs mathematical operations on the elliptic curve to confirm that the signature was indeed generated using the corresponding private key 514 and that the data has not been altered.

In addition to validating the ECDSA signature, the BMC OS 130 may also verify the integrity of the manifest table within the firmware image. The manifest table contains metadata and hashes of various components of the firmware image. To achieve a Chain of Root of Trust (CROT) for the firmware image, the BMC OS 130 calculates the hash of the manifest table and compares it to a hash value stored in another section of the firmware image. This additional verification step determines whether the manifest table itself has been tampered with or modified. By verifying the manifest table hash, the BMC OS 130 establishes a trusted chain of integrity checks, confirming that the metadata and hashes stored in the manifest table are genuine and have not been altered. This verification complements the ECDSA signature validation of the firmware image, providing an extra layer of security.

If the firmware image of the particular hardware component is verified, the BMC OS 130 allows the hardware component to be powered on or reset. The hardware component then loads the verified firmware image from its NVM into its volatile memory and executes the firmware to boot up the hardware component.

For example, when the BMC OS 130 determines that the firmware image 486 of the FPGA 466 stored in the NVM 467 is authentic and has not been tampered with, the BMC OS 130 allows the FPGA 466 to be powered on or reset. The FPGA 466 then loads the verified firmware image 486 from the NVM 467 into its volatile memory and executes the firmware image 486 to boot up the FPGA 466.

On the other hand, if the firmware image of the particular hardware component fails the verification, the BMC OS 130 prevents the hardware component from being powered on or reset. The BMC OS 130 may also log the failure event and notify the system administrator or user about the compromised firmware image.

The BMC 102 verifies the integrity and authenticity of the firmware images of the hardware components before allowing them to boot up. Only trusted and unmodified firmware is executed on the hardware components. This prevents unauthorized modifications or malicious code injection into the firmware, enhancing the overall security of the server system.

The firmware verification process can be applied to various hardware components connected to the BMC 102, such as the NIC 462, the RAID 464, the FPGA 466, the CPLD 468, the GPU 470, and the PCIe switch 450. Each component may have its own NVM to store its firmware image, and the BMC OS 130 can access and verify the firmware image of each component independently.

In certain configurations, the size of the firmware image may vary depending on the hardware component. For smaller firmware images, such as those of the CPLD 468 or the PCIe switch 450, the entire firmware image can be read by the BMC OS 130 and verified using the ECDSA signature verification algorithm. However, for larger firmware images, such as those of the GPU 470, the BMC OS 130 may employ a two-stage verification process similar to the one used for the BIOS firmware validation.

In the two-stage verification process, the firmware image is divided into two sections: an initial boot block (IBB) and the remaining firmware sections. The IBB is a small, critical section of the firmware that is responsible for initializing the hardware component and verifying the remaining firmware sections. The BMC OS 130 first verifies the integrity and authenticity of the IBB using the ECDSA signature verification algorithm. If the IBB is verified, the BMC OS 130 allows the hardware component to load and execute the IBB. The IBB then proceeds to verify the remaining firmware sections before allowing the hardware component to fully boot up.

By employing the two-stage verification process for larger firmware images, the BMC 102 optimizes the verification process and reduces the time required for the BMC OS 130 to read and verify the entire firmware image. This approach enables a secure and efficient booting process for hardware components with larger firmware images.

Overall, the firmware verification and booting process for hardware components, as managed by the BMC 102, provides a comprehensive security mechanism to protect the server system from unauthorized firmware modifications; thus, only trusted firmware is executed on the hardware components.

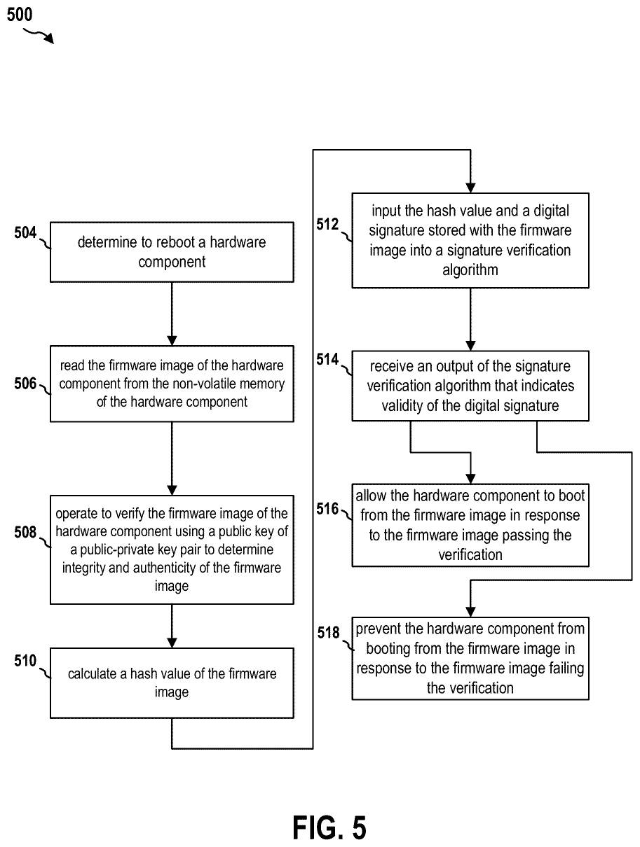

FIG. 5 is a flow chart 500 of a method (process) for verifying and booting a firmware image of a hardware component. The method may be performed by a BMC (e.g., the BMC 102). In operation 504, the BMC determines to reboot a hardware component. A firmware image for the hardware component is stored in a non-volatile memory of the hardware component. The hardware component may be one of a network interface card (NIC), a redundant array of independent disks (RAID) controller, a field-programmable gate array (FPGA), a complex programmable logic device (CPLD), a graphics processing unit (GPU), or a Peripheral Component Interconnect Express (PCIe) switch.

In operation 506, the BMC reads the firmware image of the hardware component from the non-volatile memory of the hardware component. In operation 508, the BMC operates to verify the firmware image of the hardware component using a public key of a public-private key pair to determine integrity and authenticity of the firmware image. The public key is stored in a BMC firmware image. In certain configurations, the public key includes an Elliptic Curve (EC) public key, and the BMC firmware image stores X and Y components representing coordinates of the public key on an elliptic curve.

The verification process includes operations 510, 512, and 514. In operation 510, the BMC calculates a hash value of the firmware image. In operation 512, the BMC inputs the hash value and a digital signature stored with the firmware image into a signature verification algorithm. In certain configurations, the digital signature comprises an Elliptic Curve Digital Signature Algorithm (ECDSA) signature generated by signing the hash value using a private key of the public-private key pair. In operation 514, the BMC receives an output of the signature verification algorithm that indicates validity of the digital signature.

In certain configurations, the BMC verifies the integrity of a manifest table within the firmware image by calculating a hash of the manifest table and comparing the calculated hash to a stored hash value in the firmware image. In certain configurations, the BMC verifies an initial boot block (IBB) of the firmware image using the public key. The IBB includes a first section of the firmware image. The BMC then allows the hardware component to load and execute the IBB to verify remaining sections of the firmware image.

In operation 516, the BMC allows the hardware component to boot from the firmware image in response to the firmware image passing the verification. In certain configurations, the BMC allows the hardware component to load the firmware image from the non-volatile memory into a volatile memory of the hardware component and execute the firmware image. In certain configurations, the BMC controls power sequencing of the hardware component. The BMC powers on the hardware component after the firmware image passes the verification. In operation 518, the BMC prevents the hardware component from booting from the firmware image in response to the firmware image failing the verification.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of a baseboard management controller (BMC), comprising:
determining to reboot a hardware component, wherein a firmware image for the hardware component is stored in a non-volatile memory of the hardware component;
reading, by the BMC, the firmware image of the hardware component from the non-volatile memory of the hardware component;
verifying, by the BMC using a public key of a public-private key pair, the firmware image of the hardware component to determine integrity and authenticity of the firmware image, wherein the public key is stored in a BMC firmware image; and
allowing, by the BMC, the hardware component to boot from the firmware image in response to the firmware image passing the verification.

2. The method of claim 1, further comprising:
preventing, by the BMC, the hardware component from booting from the firmware image in response to the firmware image failing the verification.

3. The method of claim 1, wherein the verifying the firmware image comprises:
calculating a hash value of the firmware image;
inputting the hash value and a digital signature stored with the firmware image into a signature verification algorithm; and
receiving an output of the signature verification algorithm that indicates validity of the digital signature.

4. The method of claim 3, wherein the digital signature comprises an Elliptic Curve Digital Signature Algorithm (ECDSA) signature generated by signing the hash value using a private key of the public-private key pair.

5. The method of claim 1, wherein the verifying the firmware image comprises:
verifying integrity of a manifest table within the firmware image by calculating a hash of the manifest table and comparing the calculated hash to a stored hash value in the firmware image.

6. The method of claim 1, wherein allowing the hardware component to boot from the firmware image comprises:
allowing the hardware component to load the firmware image from the non-volatile memory into a volatile memory of the hardware component and execute the firmware image.

7. The method of claim 1, wherein the hardware component is one of:
a network interface card (NIC), a redundant array of independent disks (RAID) controller, a field-programmable gate array (FPGA), a complex programmable logic device (CPLD), a graphics processing unit (GPU), or a Peripheral Component Interconnect Express (PCIe) switch.

8. The method of claim 1, wherein the BMC controls power sequencing of the hardware component, the method further comprising:
powering on the hardware component by the BMC after that the firmware image passes the verification.

9. The method of claim 1, wherein the public key comprises an Elliptic Curve (EC) public key, and wherein the BMC firmware image stores X and Y components representing coordinates of the public key on an elliptic curve.

10. The method of claim 1, wherein the verifying the firmware image comprises:
verifying an initial boot block (IBB) of the firmware image using the public key, wherein the IBB comprises a first section of the firmware image; and
allowing the hardware component to load and execute the IBB to verify remaining sections of the firmware image.

11. A baseboard management controller (BMC) comprising:
a processor; and
a memory coupled to the processor, wherein the processor is configured to:
determine to reboot a hardware component, wherein a firmware image for the hardware component is stored in a non-volatile memory of the hardware component;
read the firmware image of the hardware component from the non-volatile memory of the hardware component;
verify, using a public key of a public-private key pair, the firmware image of the hardware component to determine integrity and authenticity of the firmware image, wherein the public key is stored in a BMC firmware image; and
allow the hardware component to boot from the firmware image in response to the firmware image passing the verification.

12. The BMC of claim 11, wherein the processor is further configured to:
prevent the hardware component from booting from the firmware image in response to the firmware image failing the verification.

13. The BMC of claim 11, wherein to verify the firmware image, the processor is configured to:
calculate a hash value of the firmware image;
input the hash value and a digital signature stored with the firmware image into a signature verification algorithm; and
receive an output of the signature verification algorithm that indicates validity of the digital signature.

14. The BMC of claim 13, wherein the digital signature comprises an Elliptic Curve Digital Signature Algorithm (ECDSA) signature generated by signing the hash value using a private key of the public-private key pair.

15. The BMC of claim 11, wherein to verify the firmware image, the processor is configured to:
verify integrity of a manifest table within the firmware image by calculating a hash of the manifest table and comparing the calculated hash to a stored hash value in the firmware image.

16. The BMC of claim 11, wherein to allow the hardware component to boot from the firmware image, the processor is configured to:
allow the hardware component to load the firmware image from the non-volatile memory into a volatile memory of the hardware component and execute the firmware image.

17. The BMC of claim 11, wherein the hardware component is one of:
a network interface card (NIC), a redundant array of independent disks (RAID) controller, a field-programmable gate array (FPGA), a complex programmable logic device (CPLD), a graphics processing unit (GPU), or a Peripheral Component Interconnect Express (PCIe) switch.

18. The BMC of claim 11, wherein the BMC controls power sequencing of the hardware component, and wherein the processor is further configured to:
power on the hardware component after the firmware image passes the verification.

19. The BMC of claim 11, wherein the public key comprises an Elliptic Curve (EC) public key, and wherein the BMC firmware image stores X and Y components representing coordinates of the public key on an elliptic curve.

20. A non-transitory computer-readable medium storing instructions which when executed by a processor of a baseboard management controller (BMC) cause the BMC to:
determine to reboot a hardware component, wherein a firmware image for the hardware component is stored in a non-volatile memory of the hardware component;
read the firmware image of the hardware component from the non-volatile memory of the hardware component;
verify, using a public key of a public-private key pair, the firmware image of the hardware component to determine integrity and authenticity of the firmware image, wherein the public key is stored in a BMC firmware image; and
allow the hardware component to boot from the firmware image in response to the firmware image passing the verification.
